(19) United States
(12) Patent Application Publication
(10) Pub. No.: US 2008/0253266 A1
(43) Pub. Date: Oct. 16, 2008

(54) OPTICAL PICKUP DEVICE AND OPTICAL DISK APPARATUS

(75) Inventor: Kenji NAGATOMI, Kaidu-Shi (JP)

Correspondence Address: DITTHAVONG MORI & STEINER, P.C., 918 Prince St., Alexandria, VA, 22314, US

(73) Assignee: SANYO ELECTRIC CO., LTD., Moriguchi-shi (JP)

(21) Appl. No.: 12/101,530

(22) Filed: Apr. 11, 2008

(30) Foreign Application Priority Data
Apr. 13, 2007 (JP) 2007-106575

(51) Int. Cl. G11B 7/135

(52) U.S. Cl. 369/112.24

(57) ABSTRACT

Optical characteristics of laser beams guided to first and second objective lenses are adjusted by integrally driving first and second lens elements. The first and second lens elements are disposed such that the second lens element is located at a position shifted in an optical axis direction of the laser beam by a predetermined distance from a control operation position of the second lens element when the first lens element is located at a control operation position of the first lens element.

This application claims priority under 35 U.S.C. Section 119 of Japanese Patent Application No. 2007-106575 filed Apr. 13, 2007, entitled “OPTICAL PICKUP DEVICE AND OPTICAL DISK APPARATUS”.

### BACKGROUND OF THE INVENTION

1. Field of the Invention

The present invention relates to an optical pickup device and an optical disk apparatus into which the optical pickup device is incorporated, particularly to a compatible type optical pickup device sorting a laser beam emitted from a common light source into two objective lenses and an optical disk apparatus into which the optical pickup device is incorporated.

2. Description of the Related Art

Currently, there are two optical disks, i.e., BD (Blu-ray Disc) and HDDVD (High-Definition Digital Versatile Disc), in which a laser beam having a blue wavelength is used. Because BD and HDDVD differ from each other in a thickness of a cover layer, two objective lenses compatible with BD and HDDVD are provided in the optical pickup device compatible with both BD and HDDVD, and the laser beam having the blue wavelength emitted from one semiconductor laser is sorted into the objective lenses by an optical system respectively.

A liquid crystal cell and a polarization beam splitter can be used as a configuration in which the laser beam is sorted into the two objective lenses. In the configuration, a polarization direction of the laser beam is changed into one of P-polarized light and S-polarized light with respect to the polarization beam splitter by the liquid crystal cell. In the case of P-polarized light, the laser beam is transmitted through the polarization beam splitter and guided to a first objective lens. In the case of the S-polarized light, the laser beam is reflected by the polarization beam splitter and guided to the first objective lens.

However, because the method for sorting the laser beam into the two objective lenses is provided in the configuration, not only the configuration is complicated but also the number of components is increased. The cost is increased in the optical pickup device, because the liquid crystal cell is used as the optical path sorting method. Disadvantageously the intensity of the laser beam is attenuated when the laser beam passes through the liquid crystal cell. There is also the need for additional circuit and configuration which drive and control the liquid crystal cell depending on which objective lens the laser beam is guided to.

### SUMMARY OF THE INVENTION

In accordance with a first aspect of the present invention, an optical pickup device includes a laser beam source which emits a laser beam having a predetermined wavelength; first and second objective lenses which cause the laser beam to converge onto a recording medium; an objective lens actuator which integrally drives the first and second objective lenses; an optical path dividing element which is disposed between the laser beam source and the first and second objective lenses; first and second optical systems which guide the two laser beams split by the optical path dividing element to the first and second objective lenses respectively; first and second lens elements which are disposed in the first and second optical systems respectively; and a lens element actuator which integrally displaces the first and second lens elements in an optical axis direction of the laser beam, wherein the lens element actuator supports the first and second lens elements such that the second lens element is located at a position shifted from a control operation position of the second lens element by a predetermined distance in an optical axis direction of the laser beam when the first lens element is located at a control operation position of the first lens element and such that the first lens element is located at a position shifted from the control operation position of the first lens element by a predetermined distance in the optical axis direction of the laser beam when the second lens element is located at the control operation position of the second lens element.

In the optical pickup device according to the first aspect, when the first lens element is located at the control operation position, the second lens element is located at the position shifted from the control operation position by the predetermined distance in the optical axis direction of the laser beam. Therefore, the photodetector is irradiated with the laser beam (flare light) through the second lens element while the laser beam (flare light) is largely spread, and the reproduction signal is not largely deteriorated by the laser beam (flare light) even if the photodetector is irradiated with the laser beam (flare light). Similarly, when the second lens element is located at the control operation position, because the photodetector is irradiated with the laser beam (flare light) through the first lens element while the laser beam (flare light) is largely spread, the reproduction signal is not largely deteriorated by the laser beam (flare light). Therefore, the reproduction operation can smoothly be performed in the optical pickup device according to the first aspect.

In the optical pickup device according to the first aspect, the positional relationship between the first and second lens elements is adjusted to achieve the smooth reproduction operation without providing the additional method for switching the laser beam optical paths. Therefore, according to the optical pickup device of the first aspect, the simple configuration, the decreased number of components, and the simplified control can be achieved in the compatible type pickup device in which the two objective lenses are used.

In accordance with a second aspect of the present invention, an optical disk apparatus includes an optical pickup device according to the first aspect of the present invention; and a servo circuit which controls the optical pickup device, wherein the servo circuit controls the lens element actuator to adjust optical characteristics of the laser beams incident to the first and second objective lenses. Accordingly, the same effect as the optical pickup device according to the first aspect is obtained in the optical disk apparatus according to the second aspect.

### BRIEF DESCRIPTION OF THE DRAWINGS

The above and further objects and novel features of the present invention will more fully appear from the following description of embodiments with reference to the accompanying drawings, in which:

FIGS. 1A and 1B show a configuration of an optical pickup device according to an embodiment of the present invention, and FIG. 1C shows a polarization direction of a laser beam;

FIGS. 2A and 2B are views explaining a drive stroke of a lens holder according to the embodiment;

FIGS. 3A and 3B are views explaining a relationship between a moving position of the lens holder according to the embodiment and a state in which a photodetector is irradiated with a laser beam;

FIG. 4 shows a circuit configuration of an optical disk apparatus according to an embodiment of the present invention;

FIG. 5 shows a configuration of a signal amplifying circuit according to the embodiment;

FIG. 6 is a view explaining a method (first setting method) of setting a positional relationship between two collimator lenses according to the embodiment;

FIGS. 7A and 7B are views explaining another method (second setting method) of setting the positional relationship between two collimator lenses according to the embodiment;

FIGS. 8A and 8B show a modification of the optical pickup device according to the embodiment;

FIG. 9 shows another modification of the optical pickup device according to the embodiment; and

FIG. 10 shows still another modification of the optical pickup device according to the embodiment.

However, the drawings are illustrated only by way of example without limiting the scope of the present invention.

### DESCRIPTION OF PREFERRED EMBODIMENTS

Preferred embodiments of the present invention will be described below with reference to the drawings. In the following embodiments, the present invention is applied to an optical pickup device and an optical disk apparatus compatible with Blu-ray Disc (hereinafter referred to as “BD”) and HDDVD (hereinafter referred to as “HD”).

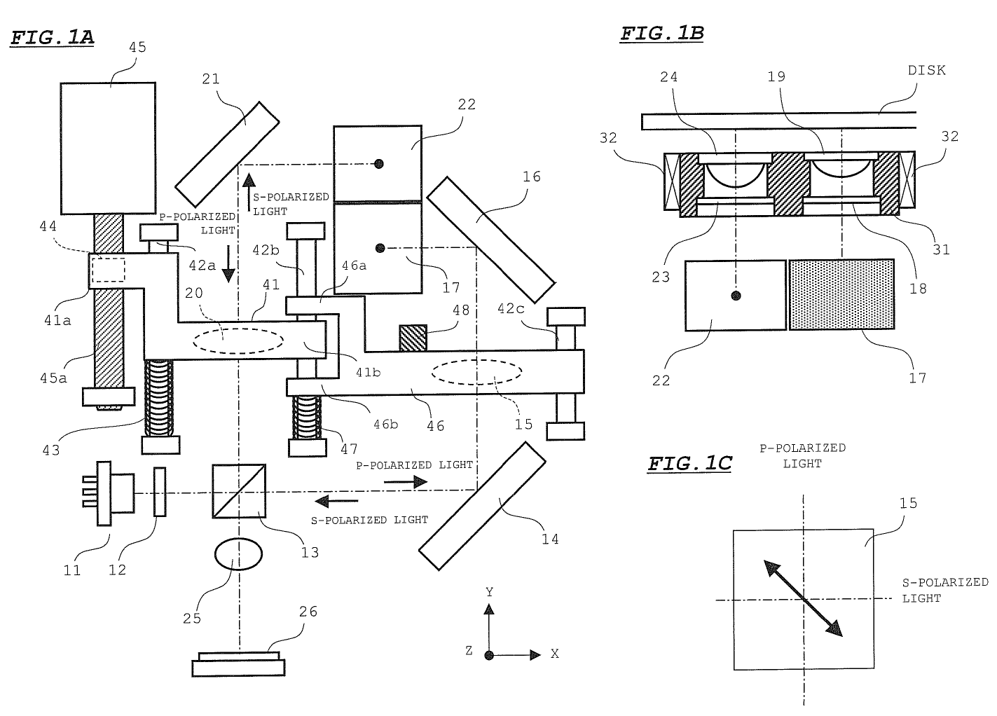

First, an optical pickup device according to an embodiment of the present invention will be described with reference to FIGS. 1A to 1C. FIG. 1A is a plan view showing an optical system of the optical pickup device, and FIG. 1B is a side view showing a portion subsequent to upwardly reflecting mirrors 17 and 22 of FIG. 1A when viewed from an X-axis direction. In FIG. 1B, an objective lens holder 31 is shown by a sectional view such that an internal structure of the objective lens holder 31 can easily be seen.

Referring to FIGS. 1A and 1B, a semiconductor laser 11 emits a laser beam having a wavelength of about 400 nm. A half-wave plate 12 is provided to adjust a polarization direction of the laser beam with respect to a polarization beam splitter 13. For example, the half-wave plate 12 is provided such that the polarization direction of the laser beam becomes the direction of 45° (arrow direction of FIG. 1C) with respect to a polarization beam splitter 13 for the P-polarized light and S-polarized light.

The polarization beam splitter 13 transmits or reflects the laser beam incident from the side of the semiconductor laser 11 according to the polarization direction of the laser beam. In the embodiment, as described above, because the half-wave plate 12 sets the polarization direction of the laser beam to 45 degrees with respect to the polarization beam splitter 13 for the P-polarized light and the S-polarized light, a half of the laser beam from the semiconductor laser 11 is transmitted through the polarization beam splitter 13 and the remaining half is reflected by the polarization beam splitter 13.

The laser beam transmitted through the polarization beam splitter 13 is reflected by a mirror 14 and the laser beam is incident to a collimator lens 15. When the collimator lens 15 is located at an initial position (described later), the collimator lens 15 converts the laser beam into parallel light. Then, the laser beam is reflected by a mirror 16, and the laser beam is further reflected toward a direction of an HD objective lens 19 by an upwardly reflecting mirror 17.

A quarter-wave plate 18 converts the light reflected from the optical disk into linearly-polarized light (S-polarized light) while converting the laser beam reflected by the upwardly reflecting mirror 17 into circularly-polarized light. The linearly polarized light is orthogonal to the polarization direction in which the laser beam is incident to the optical disk. Therefore, the laser beam reflected from the optical disk is reflected by the polarization beam splitter 13 and introduced to a photodetector 26. The HD objective lens 19 is designed to causes the laser beam incident from the side of the quarter-wave plate 18 to appropriately converge onto HD.

In the laser beam emitted from the semiconductor laser 11, the laser beam reflected by the polarization beam splitter 13 is incident to a collimator lens 20. When the collimator lens 20 is located at an initial position (described later), the collimator lens 20 converts the laser beam into parallel light. Then, the laser beam is reflected by a mirror 21, and the laser beam is further reflected toward a direction of a BD objective lens 24 by an upwardly reflecting mirror 22.

A quarter-wave plate 23 converts the light reflected from the optical disk into linearly-polarized light (P-polarized light) while converting the laser beam reflected by the upwardly reflecting mirror 22 into circularly-polarized light. The linearly polarized light is orthogonal to the polarization direction in which the laser beam is incident to the optical disk. Therefore, the laser beam reflected from the optical disk is transmitted through the polarization beam splitter 13 and introduced to the photodetector 26. The BD objective lens 24 is designed to causes the laser beam incident from the side of the quarter-wave plate 23 to appropriately converge onto BD.

An anamorphic lens 25 induces astigmatism into the laser beam reflected from the optical disk. The photodetector 26 includes a quadratic sensor in a light acceptance surface thereof, and the photodetector 26 is disposed such that an optical axis of the laser beam reflected from the optical disk pierces through an intersection point of two parting lines of the quadratic sensor. A focus error signal, a tracking error signal, and a reproduction signal are generated based on signals from the quadratic sensor.

As shown in FIG. 1B, the two quarter-wave plates 18 and 23, the HD objective lens 19, and the BD objective lens 24 are attached to the common objective lens holder 31. The objective lens holder 31 is driven in a focus direction and in a tracking direction by a well-known objective lens actuator including a magnetic circuit and a coil. Usually the coil is disposed in the objective lens holder 31. In the objective lens actuator of FIG. 1B, only a coil 32 is shown and the magnetic circuit is omitted.

In the two collimator lenses, the BD collimator lens 20 is attached to a lens holder 41. The lens holder 41 is supported by guide shafts 42a and 42b provided in parallel on the support base, and the lens holder 41 can be moved in an optical axis direction of the collimator lens 20.

A projection 41a is formed in the lens holder 41, and a rack gear 44 is provided in a lower surface of the projection 41a. On the other hand, a motor 45 is placed on the support base, and a worm gear 45a is formed, for example, in a rotary shaft of the motor 45. The motor 45 is formed by a stepping motor. The rack gear 44 provided in the lower surface of the projection 41a of the lens holder 41 is brought into press-contact with the rotary shaft of the motor 45 so as to engage the worm gear 45a. Therefore, when the motor 45 is driven, a driving force of the motor 45 is transmitted to the lens holder 41 through the worm gear 45a and rack gear 44. This enables the lens holder 41 to be moved in the optical axis direction of the collimator lens 20.

A guide shaft 42a is inserted into a spring 43, and the lens holder 41 is biased toward the direction of the motor 45 by the spring 43. The biasing force eliminates mechanical play of the motor shaft in a longitudinal direction.

The HD collimator lens 15 is attached to a lens holder 46. The lens holder 46 is supported by guide shafts 42b and 42c provided in parallel on the support base, and the lens holder 46 can be moved in the optical axis direction of the collimator lens 15. Accordingly, the guide shaft 42b supports both the lens holder 41 and the lens holder 46. Two supported portions (hereinafter referred to as “second supported portion 46a and 46b”) on the side of the lens holder 46 are provided so as to sandwich a supported portion (hereinafter referred to as “first supported portion 41b”) on the side of the lens holder 41 in the Y-axis direction of FIG. 1A. Predetermined gaps exist between the first supported portion 41b and the second supported portions 46a and 46b.

The guide shaft 42b is inserted into a spring 47, and the biasing force of the spring 47 brings the lens holder 46 into press-contact with a stopper 48 on the support base.

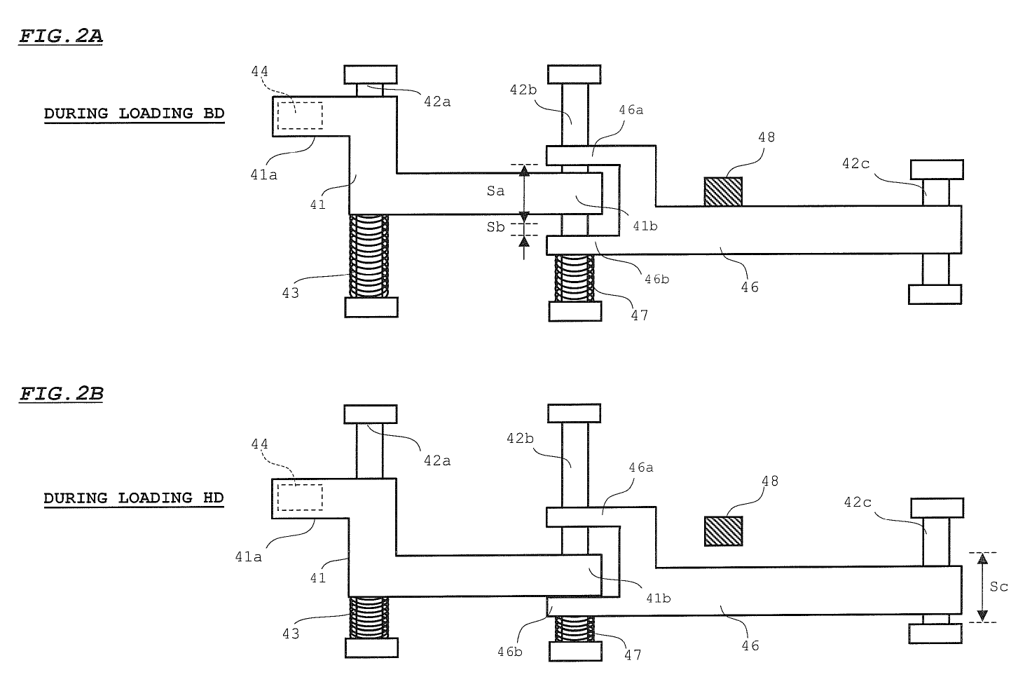

FIGS. 2A and 2B are views explaining drive strokes of the lens holders 41 and 46.

Referring to FIG. 2A, the lens holder 41 is driven in a range of a stroke Sa when an aberration correction operation is performed during loading BD. In this case, the first supported portion 41c does not abut on the second supported portions 46a and 46b, but the first supported portion 41c is moved between the second supported portions 46a and 46b. In addition to the stroke Sa, a stroke Sb remains between the first supported portion 41c and the second supported portions 46a and 46b.

When HD is loaded, the lens holder 41 is moved from the state of FIG. 2A across the stroke Sb to the lower portion of FIG. 2A. At this point, the first supported portion 41c abut on the second supported portion 46b in the middle of the movement, and the lens holder 41 is further moved to the lower portion of FIG. 2A, whereby the lens holder 46 is moved to the position of FIG. 2B against the biasing force of the spring 47. Therefore, the lens holder 46 is located at a position where aberration correction is performed by the collimator lens 17. The lens holder 46 is displaced in a range of a stroke Sc during the aberration correction operation.

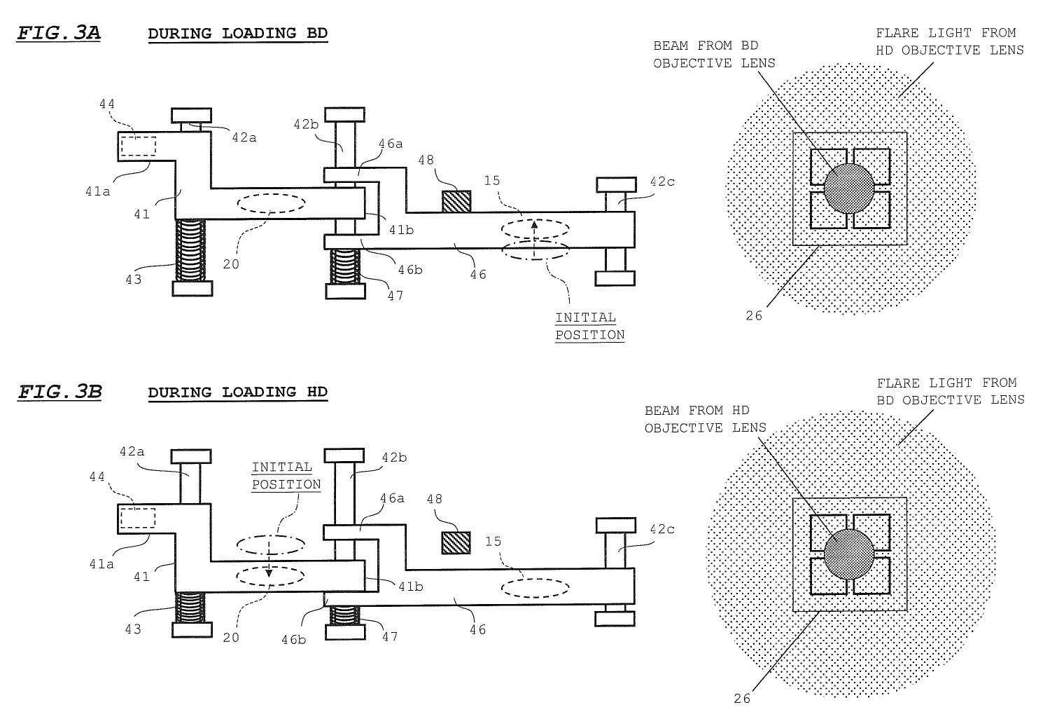

FIGS. 3A and 3B are views explaining a relationship between moving positions of the lens holders 41 and 46 and a state in which the photodetector 26 is irradiated with the laser beam.

As shown in FIG. 3A, during loading BD, the collimator lens 20 is located at the initial position (predetermined position for forming the laser beam into the parallel light) in the stroke Sa of FIG. 2A. Therefore, in the laser beam reflected from BD, the laser beam (true light) reflected through the BD objective lens 24 converges in the center of the quadratic sensor of the photodetector 26 as shown on the right side of FIG. 3A. On the other hand, the collimator lens 15 is located at a position shifted from the initial position by a predetermined distance in a direction of a broken-line arrow of FIG. 3A. Therefore, in the laser beam reflected from BD, the photodetector 26 is irradiated with the spread laser beam (flare light) reflected through the HD objective lens 19 as shown on the right side of FIG. 3A.

As shown in FIG. 3B, during loading HD, the collimator lens 15 is located at the initial position in the stroke Sc of FIG. 2B. Therefore, in the laser beam reflected from HD, the laser beam (true light) reflected through the HD objective lens 19 converges in the center of the quadratic sensor of the photodetector 26 as shown on the right side of FIG. 3B. On the other hand, the collimator lens 20 is located at a position shifted from the initial position by a predetermined distance in a direction of a broken-line arrow of FIG. 3B. Therefore, in the laser beam reflected from HD, the photodetector 26 is irradiated with the laser beam (flare light) reflected through the BD objective lens 24 while the laser beam is spread on a predetermined range as shown on the right side of FIG. 3B.

At this point, the two collimator lenses 15 and 20 are disposed during loading BD such that the photodetector 26 is irradiated with the flare light through the HD objective lens 19 while the flare light is sufficiently spread to an extent that the flare light has no influence on the BD reproduction operation. The two collimator lenses 15 and 20 are disposed during loading HD such that the photodetector 26 is irradiated with the flare light through the BD objective lens 24 while the flare light is sufficiently spread to an extent that the flare light has no influence on the HD reproduction operation. For example, the spread of the flare light is adjusted on the photodetector 26 by the positions where the two collimator lenses 15 and 20 are disposed such that a signal component of the flare light becomes a DC component for the reproduction RF signal.

That is, in the embodiment, the positional relationship between the two collimator lenses 15 and 20 is set such that the flare light has no influence on the reproduction operation of the target optical disk. Therefore, the reproduction operation can smoothly be performed to the target optical disk even if the target optical disk is irradiated with the laser beam through the HD objective lens 19 and the BD objective lens 24.

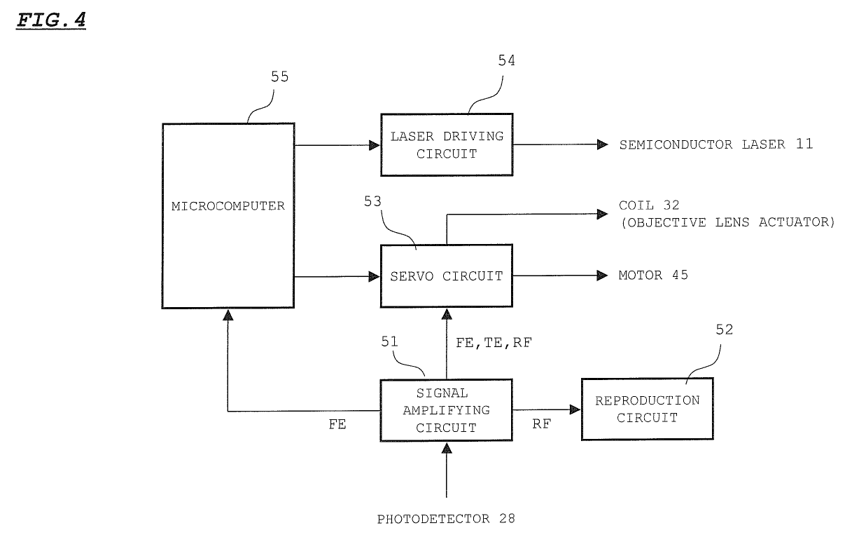

FIG. 4 shows a circuit configuration of an optical disk apparatus into which the optical pickup device is incorporated. FIG. 4 shows only portions related to the optical pickup device in the circuit configuration of the optical disk apparatus.

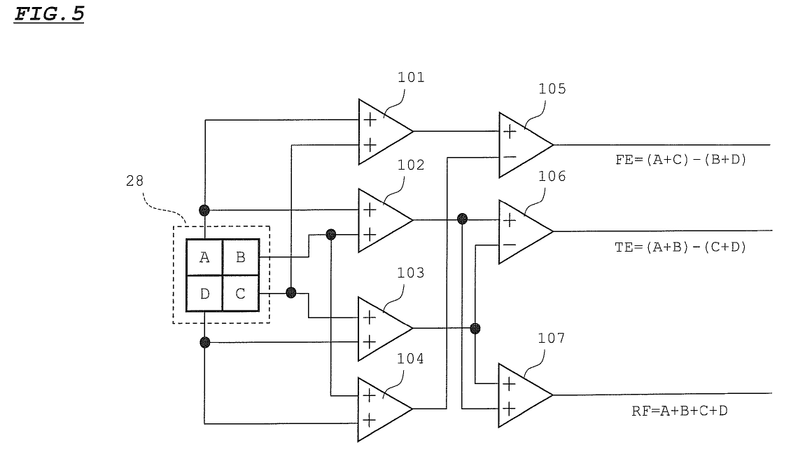

A signal amplifying circuit 51 generates a focus error signal (FE), a tracking error signal (TE), and a reproduction signal (RF) based on the signals inputted from the photodetector 28. FIG. 5 shows a configuration of the signal amplifying circuit 51. As shown in FIG. 5, the signal amplifying circuit 51 includes five adding circuits 101 to 104 and 107 and two subtracting circuits 105 and 106. As described above, the quadratic sensor is disposed in the photodetector 28. Assuming that A to D are signals from the sensors A to D shown in FIG. 5, the focus error signal (FE), the tracking error signal (TE), and the reproduction signal (RF) are generated by computations of FE=(A+C)−(B+D), TE=(A+B)−(C+D), and RF=A+B+C+D, respectively.

Referring again to FIG. 4, a reproduction circuit 52 reproduces data by processing the reproduction signal (RF) inputted from the signal amplifying circuit 51.

A servo circuit 53 generates a focus servo signal and a tracking servo signal based on the focus error signal (FE) and tracking error signal (TE) inputted from the signal amplifying circuit 51, and the servo circuit 53 supplies the focus servo signal and the tracking servo signal to the coil 32 (objective lens actuator) in the optical pickup device. In reproducing BD and HD, the servo circuit 53 monitors the reproduction signal (RF) inputted from the signal amplifying circuit 51, the servo circuit 53 generates a servo signal (aberration servo signal) to drive and control the collimator lenses 22 and 17 such that the reproduction signal (RF) becomes the best, and the servo circuit 53 supplies the servo signal to the motor 45 in the optical pickup device.

Further, the servo circuit 53 supplies a signal to the motor 45 to locate the lens holder 41 at one of a first position (initial position of collimator lens 22) and a second position (initial position of collimator lens 17) according to a control signal inputted from a microcomputer 55. Additionally, the servo circuit 53 supplies a focus pull-in signal to the coil 32 (objective lens actuator) in the optical pickup device.

A laser driving circuit 54 drives the semiconductor laser 11 in the optical pickup device according to the control signal inputted from the microcomputer 55. The microcomputer 55 controls each unit according to a program stored in a built-in memory.

Next, an operation of the optical pickup device will be described below with reference to FIGS. 1A and 1B.

When BD is loaded in the optical disk apparatus, the lens holder 41 is located at the first position. Therefore, the collimator lens 20 is located at the initial position in the stroke Sa of FIG. 2A, and the collimator lens 15 is located at the position shifted from the initial position by the predetermined distance in the optical axis direction. As described above with reference to FIG. 3A, in the laser beam reflected from BD, the laser beam (true light) reflected through the BD objective lens 24 converges in the center of the quadratic sensor of the photodetector 26, and the photodetector 26 is irradiated with the laser beam (flare light) reflected through the HD objective lens 19 while the flare light is sufficiently spread to an extent that the flare light has no influence on the reproduction operation. Therefore, the BD reproduction operation is performed by the laser beam through the BD objective lens 24.

When HD is loaded in the optical disk apparatus, the lens holder 41 is located at the second position. Therefore, the collimator lens 15 is located at the initial position in the stroke Sc of FIG. 2B, and the collimator lens 20 is located at the position shifted from the initial position by the predetermined distance in the optical axis direction. As described above with reference to FIG. 3B, in the laser beam reflected from HD, the laser beam (true light) reflected through the HD objective lens 19 converges in the center of the quadratic sensor of the photodetector 26, and the photodetector 26 is irradiated with the laser beam (flare light) reflected through the BD objective lens 24 while the flare light is sufficiently spread to an extent that the flare light has no influence on the reproduction operation. Therefore, the HD reproduction operation is performed by the laser beam through the HD objective lens 19.

In the reproduction operation, the laser beam reflected from BD or HD is guided to the anamorphic lens 25 through the polarization beam splitter 13, the anamorphic lens 25 induces the astigmatism to the laser beam, and the laser beam converges onto the light acceptance surface (quadratic sensor) of the photodetector 26.

During BD reproduction operation, the aberration servo signal is supplied to the motor 45 to finely move the collimator lens 20 in the optical axis direction within a stroke range (stroke Sa of FIG. 2A) of the aberration correction, whereby the aberration generated in the laser beam is suppressed on BD. During HD reproduction operation, the aberration servo signal is supplied to the motor 45 to finely move the collimator lens 15 in the optical axis direction within a stroke range (stroke Sc of FIG. 2B) of the aberration correction, whereby the aberration generated in the laser beam is suppressed on HD.

In the embodiment, because the target optical disk is simultaneously irradiated with the laser beams through the HD objective lens 19 and BD objective lens 24, two S-shape curves are generated on the focus error signal based on the laser beams during focus search. Accordingly, during the focus search, it is necessary to perform the focus pull-in based on the S-shape curve (true S-shape curve) which should originally be referred to.

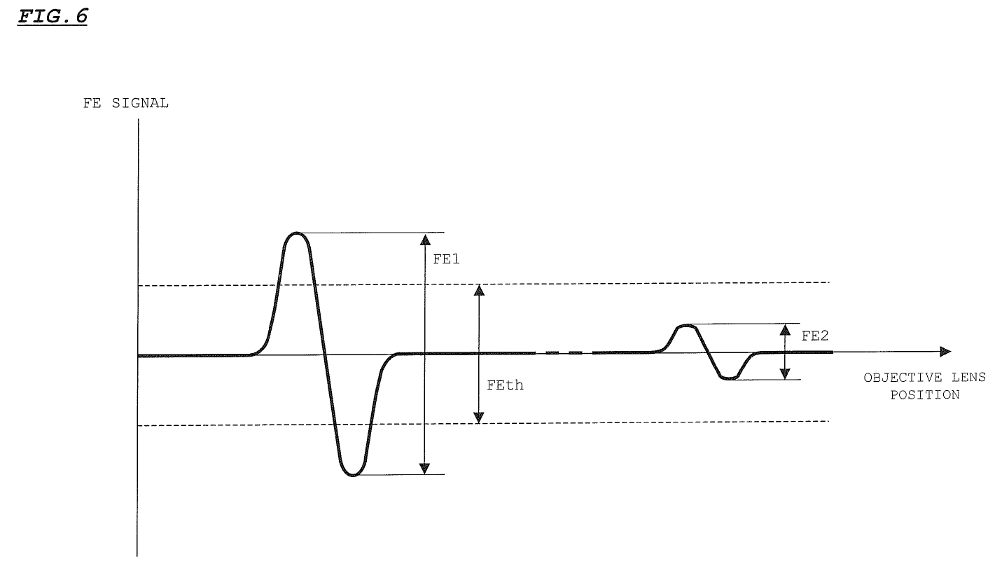

In this case, as shown in FIG. 6, the positional relationship between the two collimator lenses 15 and 20 such that an amplitude (FE2 of FIG. 6) of the S-shape curve (false S-shape curve) which should not originally be referred to is lower than a threshold FEth, which allows the focus pull-in to be performed based on the S-shape curve (true S-shape curve) which should originally be referred to. At this point, the amplitude FE2 of the false S-shape curve can be adjusted during the BD reproduction by a shift amount of the collimator lens 15 to the initial position of the collimator lens 15, and the amplitude FE2 of the false S-shape curve can be adjusted during the HD reproduction by a shift amount of the collimator lens 20 to the initial position of the collimator lens 20.

Accordingly, in view of the fact that the amplitude FE2 of the false S-shape curve is lower than the threshold FEth in addition to the influence of the flare light on the reproduction RF signal, not only the smooth reproduction operation but the stable focus pull-in can be realized by setting the positional relationship between the two collimator lenses 15 and 20.

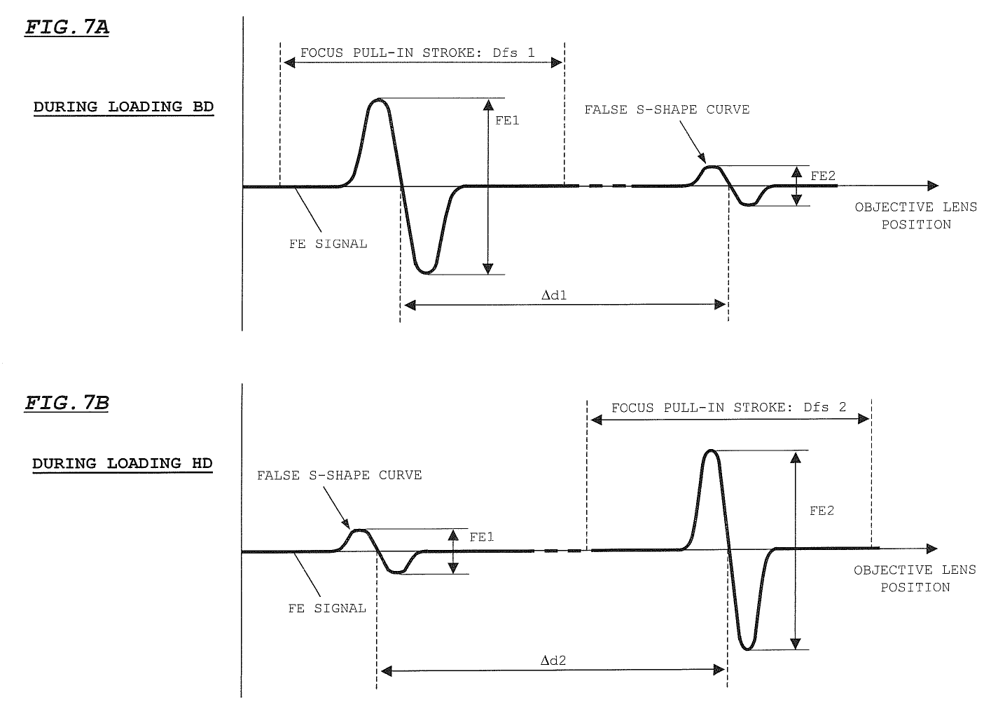

As shown in FIGS. 7A and 7B, in the case where moving strokes Dfs1 and Dfs2 of the BD objective lens 24 and HD objective lens 19 are previously set during the focus pull-in, the positional relationship between the two collimator lenses 15 and 20 is set such that the false S-shape curve is not included in the moving strokes Dfs1 and Dfs2, which allows the focus pull-in to be suppressed for the false S-shape curve.

Specifically, during loading BD as shown in FIG. 7A (focus pull-in is tried assuming that BD is the target optical disk), an interval Δd1 between the S-shape curves is set such that the false S-shape curve is not included in the focus pull-in stroke Dfs1 set for BD. During loading HD as shown in FIG. 7B (focus pull-in is tried assuming that HD is the target optical disk), an interval Δd2 between the S-shape curves is set such that the false S-shape curve is not included in the focus pull-in stroke Dfs2 set for HD. At this point, the intervals Δd1 and Δd2 can be adjusted during loading BD by the shift amount of the collimator lens 15 to the initial position of the collimator lens 15, and the intervals Δd1 and Δd2 can be adjusted during loading HD by the shift amount of the collimator lens 20 to the initial position of the collimator lens 20.

The S-shape curve intervals Δd1 and Δd2 correspond to the intervals in the laser beam axis direction of the laser beam focal position in the HD objective lens 19 and the laser beam focal position in the BD objective lens 24 respectively.

Additionally, wavefront aberration of the laser beam on the optical disk can also be used as a condition in setting the positional relationship between the collimator lenses 15 and 20. That is, in performing the reproduction operation with one of the collimator lenses, the positional relationship between the collimator lenses 15 and 20 is set such that the wavefront aberration of the laser beam through the other collimator lens is not lower than a predetermined value (for example, 70 mλ) on the optical disk. Therefore, the laser beam through the other collimator lens is not properly focused on the optical disk, which suppresses the influence of the laser beam on the reproduction operation.

Thus, in the embodiment, in performing the reproduction operation with one of the collimator lenses, because the other collimator lens is located at the position where the flare light has no influence on the reproduction operation, the reproduction operation is smoothly realized to the target optical disk. In the embodiment, the positional relationship between the two collimator lenses is adjusted to achieve the smooth reproduction operation without providing the method for switching the laser beam optical path between the objective lenses. Therefore, the simple configuration, the decreased number of components, and the simplified control can be achieved in the compatible type pickup device of the embodiment.

Accordingly, the embodiment provides the optical pickup device which can smoothly perform the reproduction operation to BD and HD with the simple configuration and the optical disk apparatus into which the optical pickup device is incorporated.

The present invention is not limited to the embodiment, but various modifications can be made.

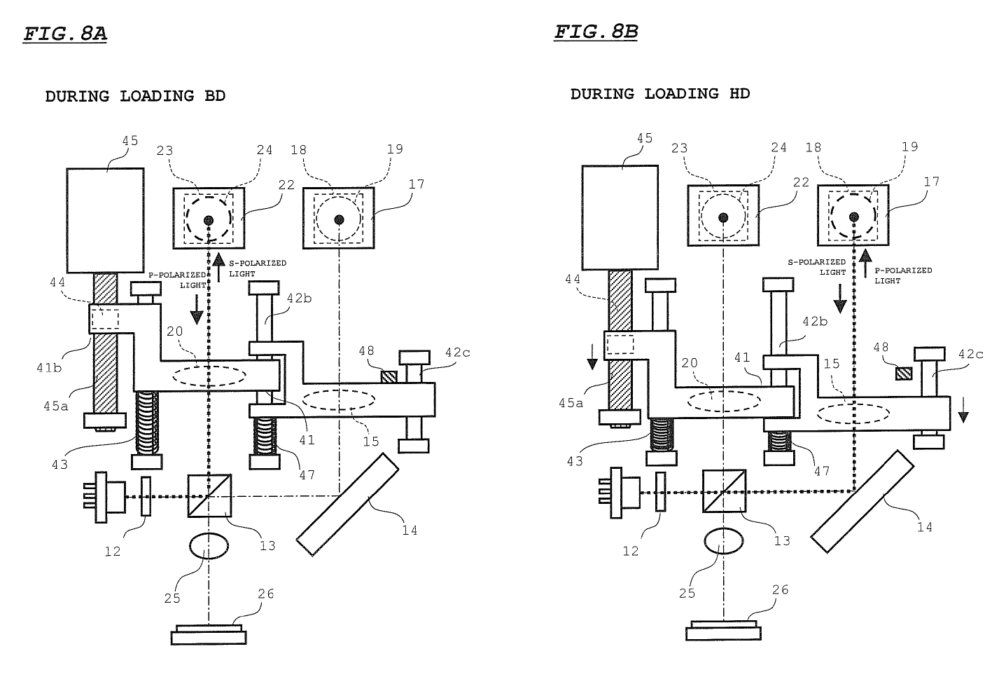

For example, the HD objective lens 19 and the BD objective lens 24 may be disposed as shown in FIGS. 8A and 8B. In this case, the mirrors 16 and 21 of FIG. 1A can be omitted to achieve the simple configuration and the reduced number of components.

In the embodiment, the tracking error signal (TE) is generated by the one-beam push pull. For example, the tracking error signal can also be generated by a DPP (Deferential Push Pull) method in which the three beams are used. In this case, the half-wave plate 12 of FIG. 1A may be replaced by a half-wave plate in which a three-beam diffraction grating is formed in the surface thereof. The half-wave plate has both a function of adjusting the polarization direction of the laser beam in the direction shown in FIG. 1C and a function of dividing the laser beam from the semiconductor laser 11 into three beams by diffraction. Additionally, in the configuration of FIG. 1A, the three-beam diffraction grating may be disposed between the half-wave plate 12 and the polarization beam splitter 13.

In the case where the three-beam DPP method is adopted, because BD differs from HD in a track pitch, an in-line pattern is applied to a pattern of the three-beam diffraction grating. Therefore, the light reflected from the optical disk can be accepted by the common light acceptance surface regardless of whether the optical disk to be recorded and reproduced is BD or HD. Because the in-line DPP method is well-known technique, the description is omitted. In this case, it is necessary to appropriately change the sensor pattern of the photodetector 26 and the signal amplifying circuit which computes the output from each sensor.

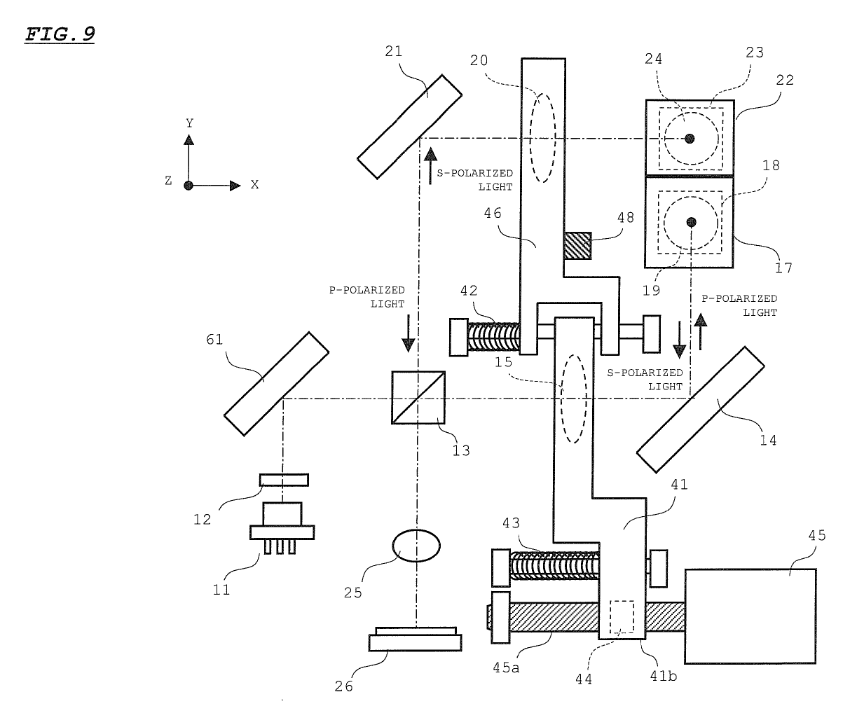

In the embodiment, the lens holder 41 is moved in the same direction as the optical axis of the laser beam reflected by the polarization beam splitter 13. Alternatively, as shown in FIG. 9, the lens holder 41 may be moved in the same direction as the optical axis of the laser beam transmitted through the polarization beam splitter 13. In this case, the collimator lenses 15 and 20 are displaced in the X-axis direction. The arrangement of the semiconductor laser 11 and the half-wave plate 12 is changed as shown in FIG. 9, and a mirror 61 is added to guide the laser beam transmitted through the half-wave plate 12 to the polarization beam splitter 13.

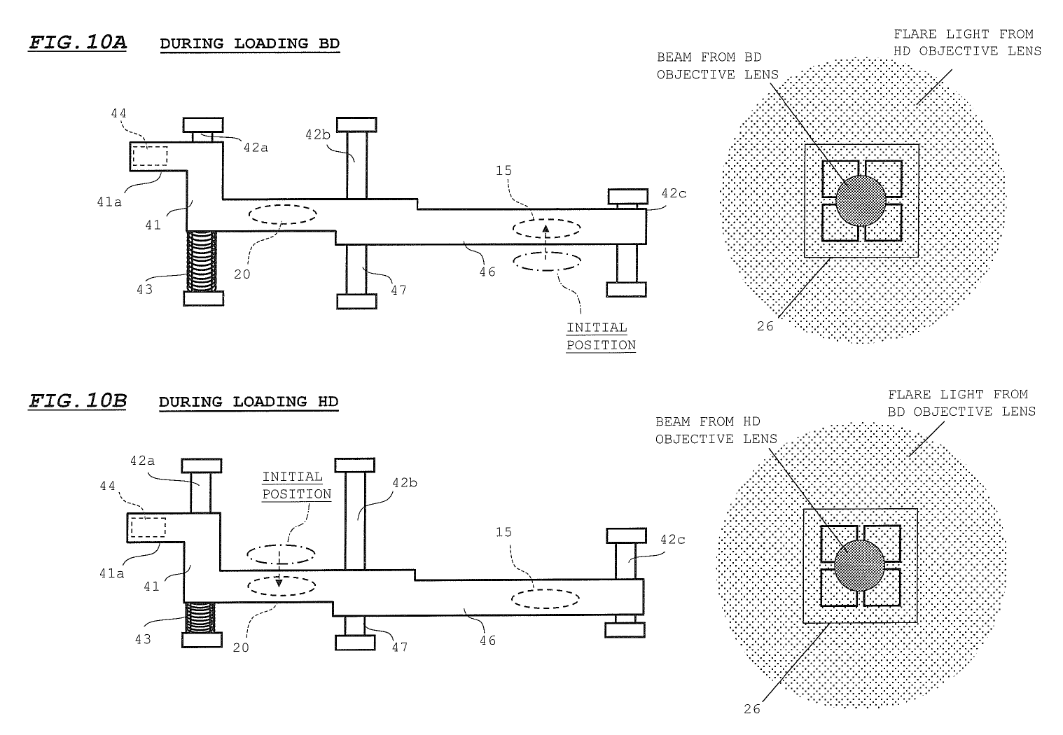

In the embodiment, the collimator lenses 20 and 15 are attached to the lens holders 41 and 46, and the gaps are provided between the first supported portion 41b and the second supported portions 46a and 46b to displace the drive strokes of the collimator lenses 20 and 15. Alternatively, as shown in FIGS. 10A and 10B, the two collimator lenses 20 and 15 may be attached to the one lens holder 41 to integrally move the collimator lenses 20 and 15. In this case, similarly to the embodiment, the collimator lens 15 in locating the lens holder 41 at the first position (initial position collimator lens 20) and the collimator lens 20 in moving the lens holder 41 to the second position (initial position of collimator lens 15) are located at the positions where the influence of the flare light on the reproduction operation is suppressed.

In the embodiment, as shown in FIG. 1C, the polarization direction of the laser beam to the polarization beam splitter 13 is set to 45 degrees with respect to the polarization plane direction of the polarization beam splitter 13. In the case where a light quantity ratio of the laser beam through the HD objective lens 19 to the laser beam through the BD objective lens 24 is changed from 1:1, the polarization direction of the laser beam may be adjusted with respect to the polarization beam splitter 13 according to the changed light quantity ratio. The adjustment is performed by changing the rotating position of the half-wave plate 12. In the case where the half-wave plate 12 is not used, the semiconductor laser 11 can be rotated about the optical axis to adjust the polarization direction of the laser beam with respect to the polarization beam splitter 13.

In the embodiment, the laser beam optical path is divided into two using the polarization beam splitter 13. Alternatively, the laser beam optical path may be divided using a half mirror or a non-polarizing mirror in which a ratio of transmission and reflection is set to a predetermined value.

In the embodiment, the present invention is applied to the optical pickup device compatible with BD and HD and the optical disk apparatus into which the optical pickup device is incorporated. However, the present invention can also be applied to other compatible optical pickup devices as appropriate.

Various changes and modifications of the embodiment can be made without departing from the scope of the technical idea though shown in claims of the present invention.

What is claimed is:

1. An optical pickup device comprising:
a laser beam source which emits a laser beam having a predetermined wavelength;
first and second objective lenses which cause the laser beam to converge onto a recording medium;
an objective lens actuator which integrally drives the first and second objective lenses;
an optical path dividing element which is disposed between the laser beam source and the first and second objective lenses;
first and second optical systems which guide the two laser beams split by the optical path dividing element to the first and second objective lenses respectively;
first and second lens elements which are disposed in the first and second optical systems respectively; and
a lens element actuator which integrally displaces the first and second lens elements in an optical axis direction of the laser beam,
wherein the lens element actuator supports the first and second lens elements such that the second lens element is located at a position shifted from a control operation position of the second lens element by a predetermined distance in an optical axis direction of the laser beam when the first lens element is located at a control operation position of the first lens element and such that the first lens element is located at a position shifted from the control operation position of the first lens element by a predetermined distance in the optical axis direction of the laser beam when the second lens element is located at the control operation position of the second lens element.

2. The optical pickup device according to claim 1, wherein a positional relationship between the first and second lens elements is set in the lens element actuator such that an amplitude of a focus error signal based on the laser beam through the second lens element is lower than a predetermined threshold when focus search is performed while the first lens element is located at the control operation position of the first lens element and such that an amplitude of a focus error signal based on the laser beam through the first lens element is lower than a predetermined threshold when the focus search is performed while the second lens element is located at the control operation position of the second lens element.

3. The optical pickup device according to claim 1, wherein a positional relationship between the first and second lens elements is set in the lens element actuator such that an S-shape curve does not emerge on a focus error signal based on the laser beam through the second lens element even if focus search is performed while the first lens element is located at the control operation position of the first lens element and such that the S-shape curve does not emerge on the focus error signal based on the laser beam through the first lens element even if the focus search is performed while the second lens element is located at the control operation position of the second lens element.

4. The optical pickup device according to claim 1, wherein a positional relationship between the first and second lens elements is set in the lens element actuator such that wavefront aberration of the laser beam through the second lens element exceeds a predetermined value on the first optical disk when the laser beam through the first lens element converges properly on a corresponding first optical disk while the first lens element is located at the control operation position of the first lens element and such that wavefront aberration of the laser beam through the first lens element exceeds a predetermined value on the second optical disk when the laser beam through the second lens element converges properly on a corresponding second optical disk while the second lens element is located at the control operation position of the second lens element.

5. The optical pickup device according to claim 1, wherein the first and second lens elements are lenses for correcting aberration generated in the laser beam.

6. The optical pickup device according to claim 1, wherein the lens element actuator includes a transmission mechanism which adjusts drive strokes of the first lens element and the second lens element.

7. An optical disk apparatus comprising:
an optical pickup device; and
a servo circuit which controls the optical pickup device,
wherein the optical pickup device includes:
a laser beam source which emits a laser beam having a predetermined wavelength;
first and second objective lenses which cause the laser beam to converge onto a recording medium;
an objective lens actuator which integrally drives the first and second objective lenses;
an optical path dividing element which is disposed between the laser beam source and the first and second objective lenses;
first and second optical systems which guide the two laser beams split by the optical path dividing element to the first and second objective lenses respectively;
first and second lens elements which are disposed in the first and second optical systems respectively; and
a lens element actuator which integrally displaces the first and second lens elements in an optical axis direction of the laser beam,
wherein the lens element actuator supports the first and second lens elements such that the second lens element is located at a position shifted from a control operation position of the second lens element by a predetermined distance in an optical axis direction of the laser beam when the first lens element is located at a control operation position of the first lens element and such that the first lens element is located at a position shifted from the control operation position of the first lens element by a predetermined distance in the optical axis direction of the laser beam when the second lens element is located at the control operation position of the second lens element,
wherein the servo circuit controls the lens element actuator to adjust optical characteristics of the laser beams incident to the first and second objective lenses.
